(19) United States
(12) Patent Application Publication
(10) Pub. No.: US 2015/0142151 A1
(43) Pub. Date: May 21, 2015

(54) METHOD FOR TRANSFORMING A THREE DIMENSIONAL DIGITAL MODEL IN A SPACE OBJECT MADE OF SHEET MATERIAL

(71) Applicant: Krasimir Chavdarov Todorov, Sofia (BG)

(72) Inventor: Krasimir Chavdarov Todorov, Sofia (BG)

(21) Appl. No.: 14/412,044

(22) PCT Filed: Jul. 1, 2013
(86) PCT No.: PCT/BG2013/000031

§ 371 Date: Dec. 30, 2014

(30) Foreign Application Priority Data
Jul. 2, 2012 (BG) 111248

(51) Int. Cl. B29C 67/00; G05B 15/02; G06F 17/50

(52) U.S. Cl. CPC B29C 67/0088; G06F 17/50; G05B 15/02; B33Y 50/02
USPC 700/98

(57) ABSTRACT

The invention relates to a method for transforming a three dimensional digital model in a space object made of sheet material. The method allows the shape forming elements of the sheet matrix to be permanently or temporarily fixed so that it can be used for circulation copies or unique pieces of the space object in material. The method according to the invention included the object is a three dimensional digital model (1), which is brought in a geometry form (2) comprising the whole three dimensional digital model—the positive (1) and representing its matrix (2), whereby the outer contour of the three dimensional digital model (1), determined by a multitude of points belonging simultaneously to the three dimensional digital model (1) and to the geometry form (2), determines the dividing contour (3).

### FIELD OF THE INVENTION

The invention relates to a method for transforming a three dimensional digital model in a space object made of sheet material, which can be used for studying three dimensional digital models and creating space objects made of sheet material, which are an exact copy of an actual object /museum piece, sculpture etc./ or generated freely one, as well as for scaling down/up models of movable and immovable cultural-historical monuments, architecture buildings and tourist destinations.

### BACKGROUND OF THE INVENTION

It is known a puzzle cube (U.S. Pat. No. 4,662,638) consisting of a multitude of interconnected in the space elements, which fully filled the cube volume and are located such way allowing dividing them from each other. Its design is characterized by every one of the elements filling the puzzle cube volume is consisted of several smaller cubes touching with their sides and tightly connected each other. Building of the puzzle cube requests at least two small cubes to be located one opposite another toward every one of the elements orientated to the three space directions.

The disadvantage of this puzzle cube is rather complicated execution of the small building cubes, from the technical point of view, which makes the shape complicated and high cost.

It is known a three dimensional puzzle (U.S. Pat. No. 4,874,176), which essentially is a three dimensional picture puzzle including a great number of puzzle pieces with the same size, and shape determined with upper, lower and side surfaces. Its elements are connected each other by their lower surfaces, as fixing is done by prior determined connecting parts and such way it is built a three dimensional shape.

The disadvantage of this three dimensional puzzle is that for constructing a three dimensional shape is requested to be connected a great number of identical in shape and size elements and there is not indication for their location in the space. A further disadvantage referring to that the shape forming elements are located and connected each other, without be placed on a base, and as a result the three dimensional shape can not be built with requested stability. It is known a three dimensional object (U.S. Pat. No. 5,817,378), made of a paper sheet, folded into two halves perpendicular each other, along the cross line, where the sheet material is provided with cut off elements, placed at intervals, and parallel each other and to one half of the folded sheet, where the shapes of the cut off pieces vary gradually from one to the another half of the folded sheet and as a result is a three dimensional shape whose foremost part differs from the hindmost part. The disadvantage of this three dimensional object made of paper sheets is that for constructing such as three dimensional object are requested further quantity of constructive elements to achieve the requested stability of the shape, together with further quantity of shape forming elements located parallel on the shape.

It is known a three dimensional puzzle (U.S. Pat. No. 5,681,041), consisting of a great number of elements where each of them has prior determined shape, made of hard sheet material. The elements are executed by parallel orientated flat planes with the same thickness. For stable building of the three dimensional puzzle shape, depending on the built shape, a preliminary determined number of elements are further furnished with frictional engaged medium to be reached the requested stability of the three dimensional figure. Such stability is reached also with the help of an additional carrying element, which also has the function of a guide during the arrangement of the shape forming elements

The disadvantage of this three dimensional puzzle is the complicated building that resulting in impossibility for full and continuous reproduction of the three dimensional object.

It is known a method for building the three dimensional shapes, specially volume puzzles, where a three dimensional object is divided in a great number of puzzle pieces—shape forming elements with different form, to be connected in the space, after that the obtained multitude of puzzle pieces—the shape forming elements, are connected each other according to a prior determined image until obtaining a space configuration, as for this purpose the puzzle pieces—shape forming elements are connected at least with two identical surfaces located perpendicularly in the space, by a dismountable connection of module type, until the three dimensional space configuration is obtained.

The disadvantage of this method is that are obtained detachable three dimensional configurations of short duration, mostly single ones, at high degree of the complexity of reproduction the shape forming elements and the whole three dimensional configuration.

It is also known a method for building a three dimensional object described in patent publication WO2003/084622, which includes dividing the object by means of its intersection with a horizontal plane orientated along one of the space co-ordinates until determination the proper contour of the object, where the object is divided into a multitude of shape forming elements with different forms. Then these elements are cut off to pieces by means of known technical devices, and after that they are placed and fixed consecutively each other, no detachable in the direction of a sheet surface limited by its own contour, as each consecutive element is fixed to the preceding one until the shape of the three dimensional object is completely reproduced.

The disadvantage of this method is that the fixing of the shape forming elements until the shape of the three dimensional object is completely reproduced, is with high degree of complexity and also it is not suitable to be used for building objects with shell.

### SUMMARY OF THE INVENTION

In view of the above cited state of the art in the considered field, the purpose of the present invention is to offer a method which differs with easy and exact transforming a three dimensional digital model into a physical space object made of sheet material, and which can be used for building varying complexity objects with high accuracy.

This purpose is achieved with a method consisting of creating shape forming elements by intersecting an object with a plane, following their cutting out and consecutive arrangement until constructing a physical space object.

According to the invention the object is a three dimensional digital model which is brought into a geometry form comprising the whole three dimensional digital model—the positive, and representing its matrix, where the outer contour of the three dimensional digital model is determined by a multitude of points, belonging simultaneously to the three dimensional digital model and to the geometry form, dividing them from each other, and determining a dividing contour. Then, depending on the polygonal mesh of the three dimensional digital model, a core is generated with specified form which is contained into the three dimensional digital model, while the multitude of points, belonging simultaneously to the positive and to the core, forms a dividing internal contour into the three dimensional digital model. Through the three dimensional digital model are drawn cross sections, whereby are established constructive joints between the positive and the matrix, constructive joints between the positive and the core, and constructive joints between the segments of the positive. Geometry forms are being generated for constructive elements and constructive guide, which fix the shape forming elements of the sheet matrix, the space object made of sheet material and the core. The three dimensional digital object consisting of the positive, the matrix, the core, the constructive elements and the constructive guide is cut with a plane intersecting the three dimensional digital object in the requested direction, and the cutting is made with spacing, preliminary determined depending on the sheet material that will be used for the physical building of the space object made of sheet material. The obtained shape forming elements are subject to preliminary preparation and then are cut out from the set sheet material by using known technical peripheral devices, and then are arranged and fixed until reaching stability by means of the sheet matrix, the core of the positive, the constructive joints between the positive segments, the constructive elements and the constructive guide. For complete finishing of the space object made of sheet material, follows removing of the sheet matrix from the positive, and the core from the positive, by breaking down the preliminary set constructive joints. For complete finishing of the sheet matrix are fixed the shape forming elements of the sheet matrix and the removed from the positive cores. As a result of the fulfilled in the indicated order actions, two independent objects are obtained simultaneously, respectively a positive, representing an exact copy of the three dimensional digital model, which is a space object made of sheet material, executed with the specified space characteristics in the three dimensional digital model, and a sheet matrix.

The main advantage of the method for transforming a three dimensional digital model in a space object made of sheet material, is that while using technical peripheral devices, with one operation are simultaneously cut out the shape forming elements of two independent from each other objects. One of them is the space object made of sheet material /the positive/, representing an exact copy of the three dimensional digital model, and the other one is a sheet matrix, with the same characteristics as the three dimensional digital model, which is used for reproducing the space object in material.

The method allows accessibility of everyone to each space form and recreating the last one according to the preliminary set instructions, as a space object made of sheet material in the shape of a space puzzle.

The method determines the possibility for reproducing the space objects made of sheet material like published issues with new characteristics, where the pages of the issue are used simultaneously as an information carrier and a constructive element /sheet material from which are removed the shape forming elements for obtaining the space object/. In this version of the method, the published issues get an additional function, namely the possibility to be transformed in space objects made of sheet material.

The method is extremely suitable for obtaining thin wall space objects made of sheet material with shell.

The method allows the shape forming elements of the sheet matrix to be permanently or temporarily fixed so that it can be used for circulation copies or unique pieces of the space object in material.

The method allows using the direction of arrangement of the shape forming elements of the physical space object made of sheet material, and the sheet matrix, to obtain their desired space symmetry. With keeping the preliminary set direction, are obtained a space object made of sheet material and a sheet matrix the same as the digital object.

When the direction is reverse to the preliminary set direction, the obtained space object made of sheet material and the sheet matrix are mirror images of the digital object. Other combinations are possible, such as a physical space object made of sheet material, that is the identical with the three dimensional digital model, and a physical space object in material, mirror image of the three dimensional digital model, obtained from mirror arranged shape forming elements of the sheet matrix.

The method allows free arrangement of the shape forming elements of the space object, different from the preliminary specified arrangement, and the result is a new original version of the space object made of sheet material.

The method allows creating very complicated space objects /with volumes intersecting each other/, as after reproduction of the space object in material, the shape forming elements of the sheet matrix are removed one by one.

The method allows using recycled paper or paper maculature.

Another advantage of the method is that the used sheet material can be purposefully bilaterally processed /front side and back side/, the reached result is an additional visual effect of the obtained space object made of sheet material that finds expression in a colored surface, limited by the outer contour depending on the angle of view.

The method allows by the type and elasticity of the constructive elements to be determined the level of stability of the physical space object made of sheet material, that allows transforming the three dimensional digital models into space objects made of sheet material, which are fully stable or partially fixed.

If during designing, is set a carrying construction for all shape forming elements, which allows their free motion in the determined for each one of them plane, and fixes them at intervals from each other, is obtained full kinetics. Another example of execution is a space object made of sheet material, where during cutting out the shape forming elements is obtained a matt structure, varying the density typical for the material of the shape forming elements /glass/. After building of the space object and its illumination is obtained a kinetics effect consisting of light reflection and refraction.

The method allows for building a space object made of sheet material to be used constructive elements made of different materials.

The method allows for building a space object made of sheet material to be used different materials for the shape forming elements, and also to be made combinations between materials.

### BRIEF DESCRIPTION OF THE DRAWINGS

Herein after is given an example for execution of the method for transforming a three dimensional digital model in a physical space object made of sheet material, shown by the help of the attached to the description figures as follows:

FIG. 1—view of the three dimensional digital model—the positive, placed in the geometry form—the matrix, and the obtained dividing contour;

FIG. 2—view of the internal dividing contour between the three dimensional digital model and the generated in the positive core with a specific form;

FIG. 3—view of a shape forming element with indicated constructive joints between the positive and the matrix, constructive joints between the positive and the core, and constructive joints between the segments of the positive;

FIG. 4—view of geometry forms for constructive elements and a constructive guide, fixing the shape forming elements of the sheet matrix, the space object made of sheet material and the core;

FIG. 5—view of the intersection by a plane of a three dimensional digital object consisting of the positive, the matrix, the core, the constructive elements and the constructive guide;

FIG. 6—view of the spacing for cutting the three dimensional digital object with a plane, determined depending on the sheet material which will be used for making the physical space object made of sheet material;

FIG. 7—view of a shape forming element of the positive and the sheet matrix;

FIG. 8—view of a partially built positive of head, where the centrally located constructive guide has a suitable geometry form, which secures the requested stability of the sheet matrix, the space object made of sheet material and the core;

FIG. 9—axonometric view of fixing the shape forming elements of the positive by the help of the sheet matrix, the core, the constructive elements and the constructive guide;

FIG. 10—axonometric view of removing the sheet matrix from the positive;

FIG. 11—view of the shape forming elements of the positive;

FIG. 12—view of the shape forming elements of the sheet matrix;

FIG. 13—view of the completed space object made of sheet material, characterized by the space characteristics set in the three dimensional digital model;

FIG. 14—view of a sheet matrix which is suitable for multiple reproduction of the three dimensional digital model as a space object in material;

FIG. 15—view of cutting out by one operation the sheet shape forming elements for obtaining a space object made of sheet material and a sheet matrix;

FIG. 16—view of a page of published issue with new characteristics, which is simultaneously an information carrier and a constructive material for the shape forming elements of the space object made of sheet material;

FIG. 17—view of a sheet matrix, and FIG. 17A—view of a sheet matrix type split die;

FIG. 18—view of a space object made of sheet material, obtained by following the preliminary set direction of arrangement, and FIG. 18A—view of a space object made of sheet material, obtained by mirror reversal of every one of its shape forming elements;

FIG. 19—view of a sheet matrix, obtained by following the preliminary set direction of arrangement, and FIG. 19A—a sheet matrix obtained by mirror reversal of every one of its shape forming elements;

FIG. 20—view of arrangement the shape forming elements of a space object made of sheet material, according to prior set order, and FIG. 20A, FIG. 20B and

FIG. 20C—view of the same shape forming elements freely ordered;

FIG. 21—view of a sheet matrix with space object in material, and FIG. 21A—view of the obtained space object in material, with the three dimensional digital model characteristics;

FIG. 22—view of kinetic space objects with the three dimensional digital model characteristics;

FIG. 23—view of kinetic effect, consisting in light reflection and refraction inside the shape forming elements of a space object made of glass.

### PRIMARY EMBODIMENT OF THE INVENTION

The method for transforming a three dimensional digital model in a space object made of sheet material according to the invention is shown by a sample for transforming a three dimensional digital model with determined complexity and shape, as the described characteristics and constructive elements of the separate objects—the sheet matrix and the space object made of sheet material do not limit the using of other elements with identical or similar function, as well as the possibility for simultaneous execution of separate operations characterizing the method, where as result are obtained space objects with the same quality and characteristics.

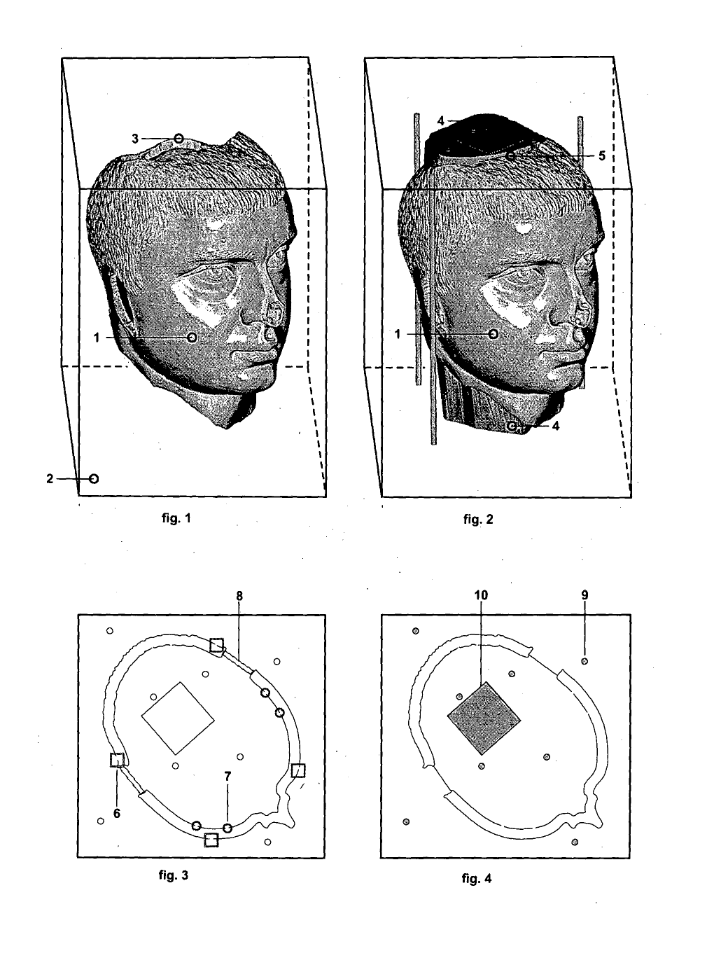

The method is executed in the already described order: a three dimensional digital model /1/ is brought in a geometry form /2/ /FIG. 1/, comprising the whole three dimensional digital model—the positive /1/ and representing its matrix /2/, where the outer contour of the three dimensional digital model /1/ is determined by a multitude of points belonging simultaneously to the three dimensional digital model /1/ and to the geometry form /2/, dividing them from each other, and determining the dividing contour /3/.

As is shown at FIG. 2, depending on the polygonal mesh of the three dimensional digital model /1/, is generated a core /4/ with specified form, as the core is contained into the positive /1/, and a multitude of points belonging simultaneously to the positive /1/ and the core /4/, forms a dividing internal contour /5/ into the three dimensional digital model /1/. Then through the three dimensional digital model are drawn cross sections whereby are established constructive joints /6/ between the positive /1/ and the matrix /2/, constructive joints /7/ between the positive /1/ and the core /4/, and the constructive joints /8/ between the segments of the positive /1/ /FIG. 3/. Geometry forms are being generated for constructive elements /9/ and constructive guide /10/, which fix the shape forming elements of the sheet matrix /2/, the space object/1/ made of sheet material and the core/4/, as is determined their mutual location /FIG. 4/.

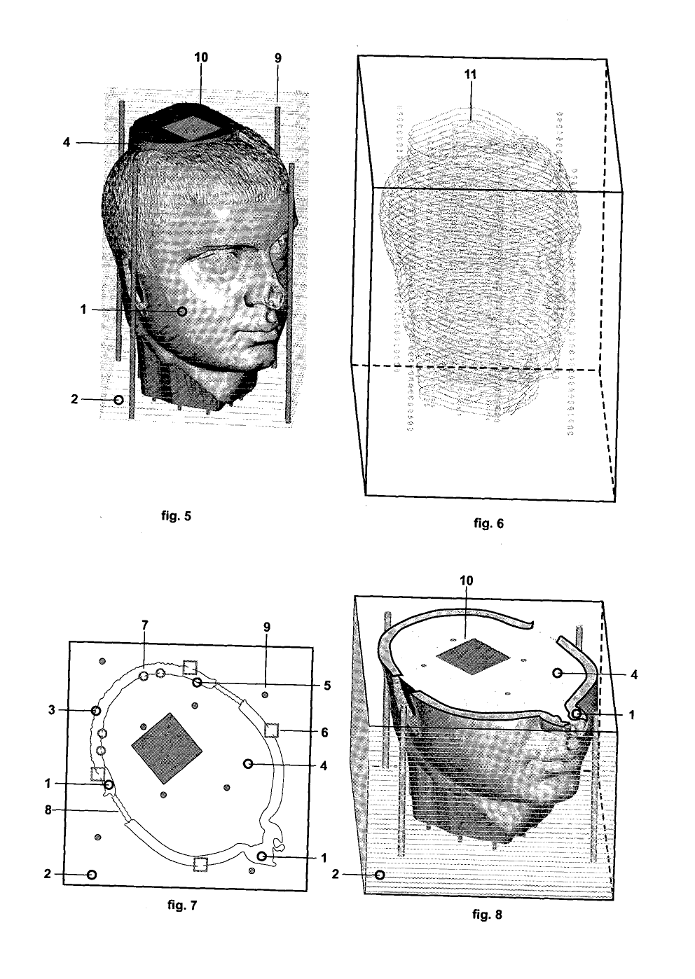

After that as it is shown at FIG. 5 the three dimensional digital object, consisting of the positive /1/, the matrix /2/, the core /4/, the constructive elements /9/ and the constructive guide /10/, is cut with a plane, intersecting the three dimensional digital model /1/ in the requested direction, and the cutting is made with spacing /11/ /FIG. 6/, preliminary determined depending on the sheet material that will be used for physical building of the space object made of sheet material. The obtained shape forming elements /FIG. 7/ are subject to preliminary preparation and then are cut out from the set sheet material by using known technical peripheral devices, after that follows their consecutive arrangement /FIG. 8/ according to the preliminary made marks on every shape forming element.

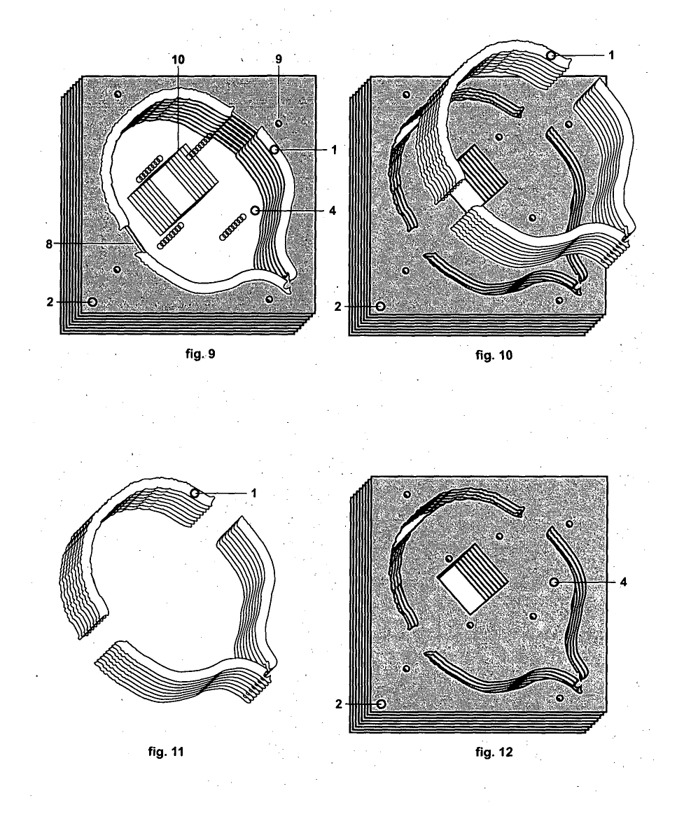

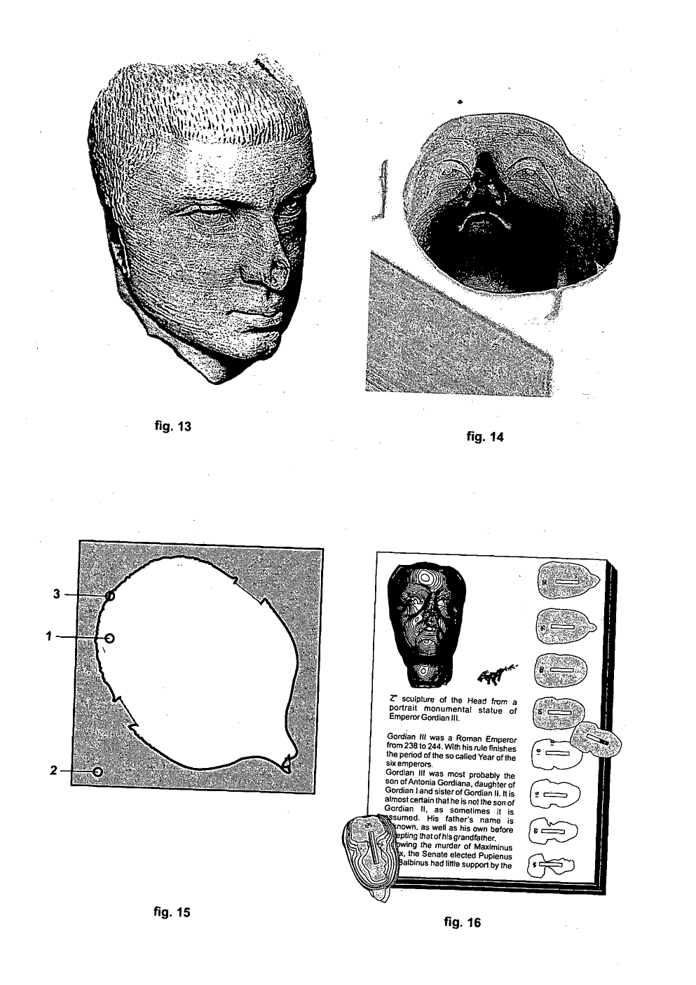

During the arrangement /FIG. 9/ of the shape forming elements of the positive /1/, the last ones are fixed by means of the sheet matrix /2/, the core /4/, the constructive joints /8/ between the segments of the positive, the constructive elements /9/ and the constructive guide /10/. After the arrangement of all shape forming elements, follows removing of the sheet matrix /2/ from the positive /1/ /FIG. 10/ and the core /4/ from the positive /1/, by breaking down the preliminary set constructive joints and finally is obtained the complete finishing of the space object /1/ made of sheet material/FIG. 11/. For the complete finishing the sheet matrix /2/ /FIG. 12/ are fixed the shape forming elements of the sheet matrix /2/ and the removed from the positive /1/ cores /4/. With the described arrangement of the shape forming elements are obtained simultaneously two independent objects—the positive /1/, /FIG. 13/ which is a space object made of sheet material, characterized by the preliminary set space characteristics in the three dimensional digital model, and the sheet matrix /2/ /FIG. 14/.

In another version of the invented method, the cutting out of the sheet shape forming elements can be executed with one operation, as is shown at FIG. 15.

The method can be used in different fields like polygraph, where one published issue can be executed with new functional characteristics, as far as every page of such issue /FIG. 16/ is simultaneously a carrier of information and constructive material for the shape forming elements.

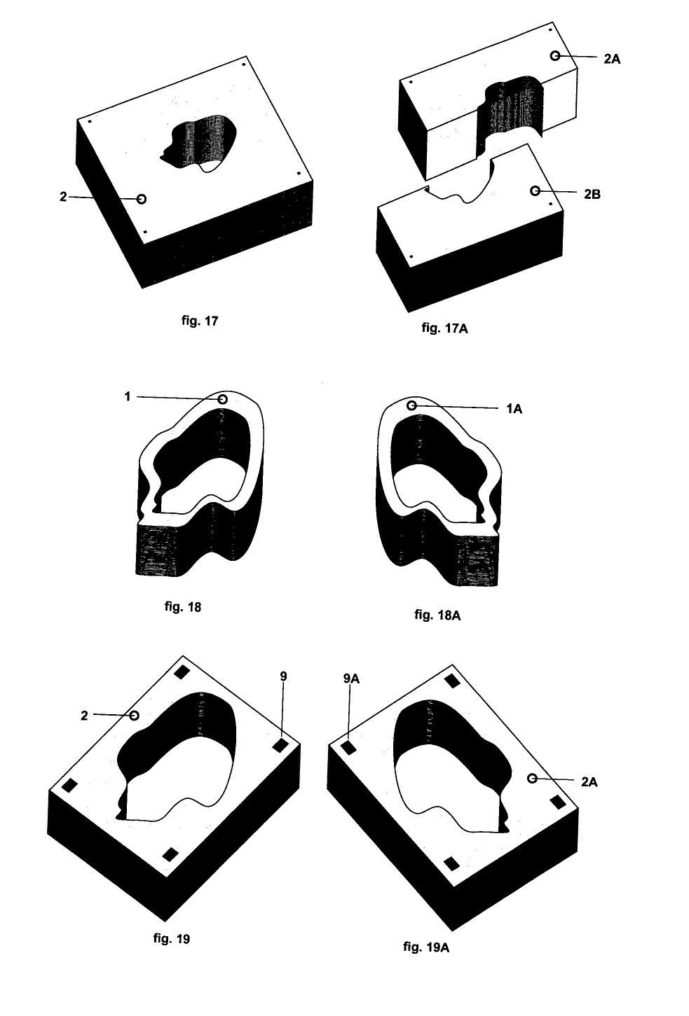

As is explained above in the method description, by cutting out the shape forming elements are obtained two independent objects, as one of them is the sheet matrix /FIG. 17/ which depending on the complexity of the object, can be executed also as a sheet matrix type split die /FIG. 17A/ consisting of at least two parts.

As a rule, the arrangement of the shape forming elements is made according to the preliminary set marks, corresponding to the space characteristics of the specified three dimensional digital model. Following the preliminary specified direction of arrangement is obtained a space object made of sheet material as is shown at FIG. 18.

The method also allows the arrangement of the shape forming elements by mirror reversal of each one of them, whereby will be obtained a space object made of sheet material as is shown at FIG. 18A. The other independent object is the sheet matrix /2/, looking like the space object made of sheet material.

FIGS. 19 and 19A show respectively a sheet matrix obtained by following the preliminary set direction of arrangement and a sheet matrix obtained by mirror reversal of the shape forming elements.

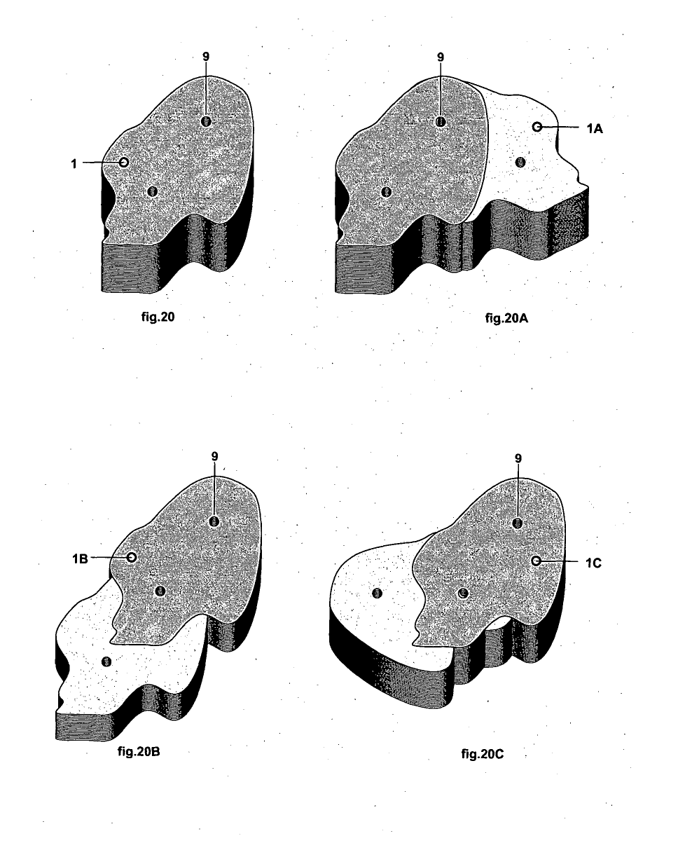

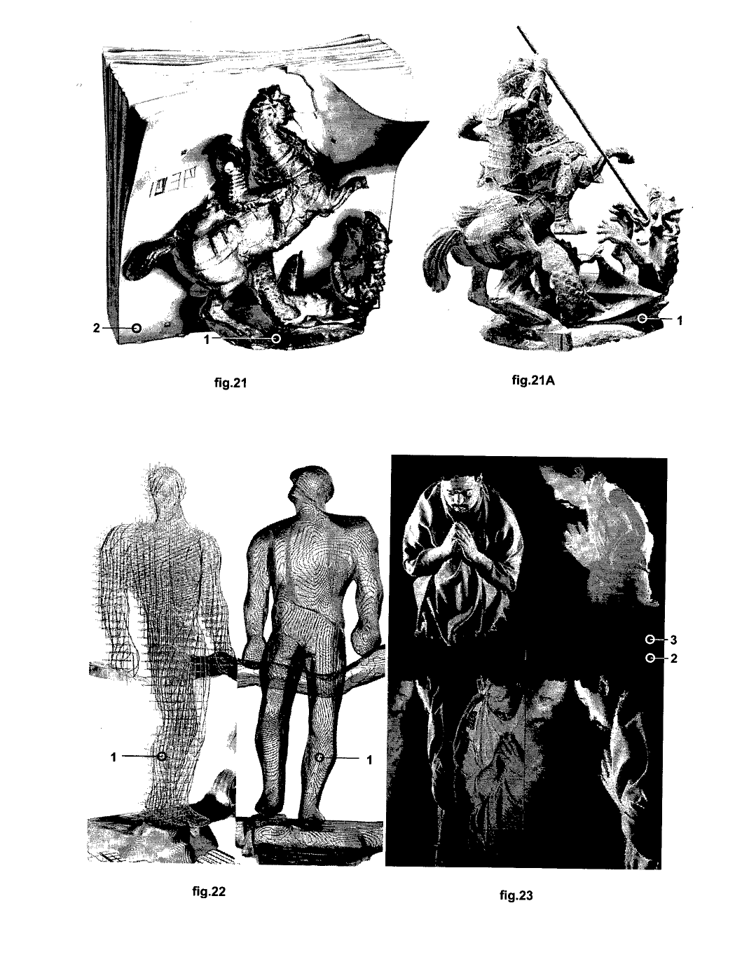

According to the method, every shape forming element has mark which defines the way, the direction and the order of its arrangement to obtain a space object made of sheet material. The method allows applying different ways for arrangement of the shape forming elements. One of them is when aiming exact recreation of the set three dimensional digital model, for which the preliminary set marks should be followed. In these cases is obtained a space object as is shown at FIG. 20.

The method allows the arrangement of the shape forming elements without following the order of the mentioned marks i.e. free arrangement, whereby are obtained the space objects shown at FIGS. 20A, 20B and 20C, with shapes different from the shape of the preliminary set three dimensional digital model.

The method according to the invention, allows constructing objects with high degree of complexity, defined by availability of the sculpture elements which form cavities, close and open areas in the space object. FIG. 21 shows a sheet matrix by means of which is built in material a complex main figure in dynamics with other objects connected to the main figure, whereby after breaking down the constructive joints and removing the shape forming elements of the sheet matrix one by one, is obtained the shown at FIG. 21 an exact copy of the set three dimensional digital model with complex form.

In one version of the method, the dividing contour between the positive and the matrix is made of material with specified thickness, and the shape forming elements are distanced from each other to preliminary specified intervals as is shown at FIG. 22, whereby the constructive elements fix and allow the free motion of the shape forming elements.

As is shown at FIG. 23 the method allows, when the shape forming elements are cut out from glass, the light reflection from the matt dividing contour to create kinetics images of the positive in the glass volume (the matrix).

1-16. (canceled)

17. A method for transforming a three dimensional digital model in a space object made of sheet material comprises:
creating shape forming elements by intersecting an object with a plane;
cutting out the shape; and
arranging the shape until constructing the space object is constructed;
wherein characterized by that the object is a three dimensional digital model, which is brought in a geometry form comprising the whole three dimensional digital model, comprising the positive and representing its matrix, whereby the outer contour of the three dimensional digital model, determined by a multitude of points belonging simultaneously to the three dimensional digital model and to the geometry form, determines the dividing contour, after that depending on the polygonal mesh of the three dimensional digital model, is generated a core with specified form, as the core is contained into the positive, and the multitude of points which belongs simultaneously to the positive and the core, forms an internal dividing contour in the three dimensional digital model, after that through the three dimensional digital model are drawn cross sections whereby are established constructive joints between the positive and the matrix, constructive joints between the positive and the core, and constructive joints between the segments of the positive, after that are being generated geometry forms for constructive elements and constructive guide, designed for fixing the shape forming elements of the sheet matrix, the space object made of sheet material and the core, whereby the three dimensional digital object, consisting of the positive, the matrix, the core, the constructive elements and the constructive guide is cut with a plane intersecting the digital object in the requested direction, as the cutting is made with spacing, preliminary determined depending on the sheet material that will be used for the physical building of the space object made of sheet material, after that the obtained shape forming elements are subject to preliminary preparation and then are cut out from the set sheet material by using known technical peripheral devices, whereby during the arrangement of the shape forming elements of the positive, the last ones are fixed by means of the sheet matrix, the core, the constructive joints between the segments of the positive, the constructive elements and the constructive guide, as for the complete finishing of the positive is made breaking down of the constructive joints whereby is removed the sheet matrix from the positive, and the core from the positive, after that for the full finishing of the sheet matrix, are fixed the shape forming elements of the matrix and the removed from the positive cores.

18. A method for transforming a three dimensional digital model in a space object made of sheet material comprises:
creating shape forming elements by intersecting an object with a plane;
cutting out the shape; and
arranging the shape until constructing the space object is constructed;
wherein the object is a three dimensional digital model, where depending on the polygonal mesh of the three dimensional digital model, is generated a core with specified form, as the core is contained into the positive, and the multitude of points belonging simultaneously to the positive and to the core, forms an internal dividing contour into the three dimensional digital model, after that through the three dimensional digital model are drawn cross sections which establish constructive joints between the positive and the core, and constructive joints between the segments of the positive, after that geometry forms are being generated for constructive elements and the constructive guide, designed for fixing the shape forming elements of the space object made of sheet material and the core, whereby the three dimensional digital object consisting of the positive, the core, the constructive elements and the constructive guide, is cut with a plane intersecting the digital object in the requested direction, as the cutting is made with spacing preliminary determined depending on the sheet material which will be used for physical building of the space object made of sheet material, after that the obtained shape forming elements are subject to preliminary preparation and are cut out from the set sheet material by using known technical peripheral devices, whereby during the arrangement of the shape forming elements of the positive, the last ones are fixed by means of the core, the constructive joints between the segments of the positive, the constructive elements and constructive guide, as for the complete finishing of the positive is made breaking down of the constructive joints and removing the core from the positive.

19. A method for transforming a three dimensional digital model in a space object made of sheet material comprises:
creating shape forming elements by intersecting an object with a plane;
cutting out the shape; and
arranging the shape until constructing the space object is constructed;
wherein the object is a three dimensional digital model, where depending on the polygonal mesh of the three dimensional digital model, are being generated geometry forms for constructive elements, which fix the shape forming elements of the space object made of sheet material, whereby the three dimensional digital object consisting of the positive and the constructive joints is cut with a plane intersecting the digital object in the requested direction, and the cutting is made with spacing, preliminary determined depending on the sheet material which will be used for physical building of the space object made of sheet material, after that the obtained shape forming elements are subject to preliminary preparation and are cut out from the set sheet material by using known technical peripheral devices, after that the shape forming elements of the space object made of sheet material are fixed by means of the constructive elements.

20. A method according to claim 17, wherein the arrangement of the shape forming elements can be made according to the preliminary set direction corresponding to the space symmetry of the three dimensional digital model.

21. A method according to claim 17, wherein the arrangement of the shape forming elements can be made in a reverse direction to the preliminary set one.

22. A method according to claim 17, wherein by possible free arrangement of the shape forming elements of the space object, different from the preliminary set one.

23. A method according to claim 17, wherein the creating space objects with volumes intersecting each other, after recreating the space object in material, the shape forming elements of the sheet matrix are removed one by one.

24. A method according to claim 17, wherein the sheet material is purposefully bilaterally processed, in particular from the front and from the back.

25. A method according to claim 17, wherein the constructive elements are flexible, as the degree of flexibility determines the stability of the created space object made of sheet material.

26. A method according to claim 17, wherein the constructive elements are so made that allow free motion of the shape forming elements in the determined for every shape forming element plane, and fix them at intervals from each other.

27. A method according to claim 17, wherein the creating of a space object made of sheet material are used shape forming elements, made of different materials such as recycled paper, paper maculature, cardboard, glass, plexiglass etc.

28. A method according to claim 17, wherein the creating of a space object made of sheet material are used shape forming elements, made of different materials, i.e. combinations between the materials, such as recycled paper and cardboard, glass and metal etc.

29. A method according to claim 17, wherein the cutting out the shape forming elements of glass material, is obtained matting of the dividing contour, which forms a structure positive, set in the sheet matrix made of glass.

30. A method according to claim 17, wherein the shape forming elements are systematized, so that following the set instructions, everybody can create on his own the space object made of sheet material.
